(19) United States
(12) Patent Application Publication
(10) Pub. No.: US 2010/0307319 A1
(43) Pub. Date: Dec. 9, 2010

(54) PLAY ASSIST DEVICE

(76) Inventor: Hirofumi Kani, Kanagawa (JP)

Correspondence Address: DARBY & DARBY P.C., P.O. BOX 770, Church Street Station, New York, NY, 10008-0770, US

(21) Appl. No.: 12/648,457

(22) Filed: Dec. 29, 2009

(30) Foreign Application Priority Data
Jun. 19, 2007 (JP) 2007-161414

(51) Int. Cl. G09B 15/06

(52) U.S. Cl. 84/485 R

(57) ABSTRACT

The invention provides a play assist device which allows a player to efficiently learn how to read and play a score. The device includes display means for displaying the upper and lower staves of a grand staff independently by a predetermined range, projecting means for projecting the images of the upper and lower staves of a grand staff above or onto the keyboard, pressed key detection means for detecting the pressed key, and control means for shifting the upper and lower staves so that the note to be played in the upper and lower staves is positioned above or on the key corresponding to the note.

### FIELD OF ART

The present invention relates to a play assist device which shows guiding indication produced from music data to a player for guiding how to play a keyboard instrument, such as a piano, electronic piano, electronic keyboard, and organ.

### BACKGROUND ART

Play assist devices for such keyboard instruments are known which provide guiding indication of a note to be played by means of LEDs, for example, by single light indication, at a position corresponding to each key of a keyboard instrument, so as to enable the player to play a music piece according to the guidance of the guiding indication on a display without referring to a score. This type of play assist devices is suitable for beginners who cannot read scores, but are not sufficiently functional for players who can manage to read scores and want to advance to a higher level. In this regard, a play assist device is also known which displays a part of a score of music to be played on a guide display of a liquid crystal device, and guides a player by successively showing with LEDs the relevant positions on the score and on the key to be played (e.g., see Patent Publication 1). With this play assist device, the relationship between notes on a score and keys of a keyboard is expressly shown, and the ability of players to read scores may be expected to be improved.

As another type of a play assist device for keyboard instruments, there is also known a device for guiding fingering. A keyboard instrument is ideally played with ten fingers of the right and left hands. If a player plays according to a play assist device with only one finger, his/her skill may not be expected to be improved. Fingering gives directions on which note is to be played with which finger, and is usually indicated on a score by numbers from 1 to 5 each assigned to each finger from the thumb to the little finger. A play assist device using this is also known which provides a guide in fingering not only by indicating the numbers for fingering near the notes or on the score shown on the guide display, but also by displaying an image of fingers to indicate which finger should be used to press a key (e.g., see Patent Publication 2).

Incidentally, aside from the discussion about play assist devices, there are known, as general display means using light, liquid crystal displays (LCDs) and electroluminescence (EL) having light sources such as incandescent bulbs, fluorescent tubes, cold-cathode tubes, light emitting diodes (LEDs), or laser diodes (LDs), as well as stereo image reproduction apparatus for displaying an image stereoscopically (e.g., see Patent Publication 3), hologram devices (e.g., see Patent Publication 4), or electric holography technique developed by NHK SCIENCE & TECHNOLOGY RESEARCH LABORATORIES.

### Patent Publication 1: JP-05-181406-A

### Patent Publication 2: JP-2000-338972-A

### Patent Publication 3: JP-2001-235708-A

### Patent Publication 4: JP-2005-283683-A

In the conventional play assist devices which display a score, however, the LCD display for this purpose is merely of such a size as to display a score by one measure. In addition, the player cannot see both the keyboard and the displayed score simultaneously, so that he eventually relies on the light of the LED and the like which is lit at a position corresponding to the key to be pressed.

### SUMMARY OF THE INVENTION

The present invention aims to solve such conventional problems. It is an object of the present invention to provide a play assist device which enables a player to learn efficiently how to read and play a score.

In order to achieve the above object, according to the present invention, there is provided a play assist device comprising: display means for displaying upper and lower staves of a grand staff independently by a predetermined range; projecting means for projecting images of said upper and lower staves of a grand staff above or onto a keyboard; pressed key detection means for detecting a pressed key; and control means for shifting said upper and lower staves so that a note to be played in the upper and lower staves is located at a position above or on a keyboard corresponding to said note. With this structure, according to music data containing information about notes and musical notation on the score of music to be played, the control means causes the display means to display a desired number of measures of the upper and lower staves of a grand staff, for example, two measures including the measure to be played now and the measure to be played next, and every time each measure is played, the display is renewed sequentially. The control means also determines whether or not to shift the upper and lower staves according to a play mode, wherein the conditions for shifting the upper and lower staves have been set up. When the control means decides to shift the upper and lower staves, it does so that the note to be played in the upper and lower staves is located at a position above or on the keyboard corresponding to the note. Thus the player may easily see the physical correspondence between the position of a note on the score shown on the display means and the position of a key of the keyboard to be actually pressed, which assists the player to clearly understand the positional relationship between the notes and the keys to be pressed. As a result, the player may efficiently learn how to read and play a score, and easily learn a skill to play from the score without relying on the play assist device.

Incidentally, the upper staff of a grand staff is a treble clef staff, and the lower staff a bass clef staff.

According to the present invention, the display means is also characterized by displaying an image of fingers at a position on the keyboard corresponding to the note to be played in the upper and lower staves. With this feature, the positional relationship between the notes and the keys to be pressed is specified, so that the player may efficiently learn how to read and play a score.

According to the present invention, the control means is also characterized by determining whether or not to proceed with the music data in accordance with a play mode, wherein the conditions for proceeding with the music data have been set up. With this feature, the control means may proceed with the music data sequentially according to the play mode, irrespective of the determination of the state of play, or proceed with the music data except when the player does not press a key even after the lapse of the time period designated by each note in the music data or of a predetermined period of time, or except when the player presses a wrong key.

According to the present invention, the play assist device further includes position adjusting means for adjusting the position of the images of the upper and lower staves projected above or on the keyboard. With this feature, the position of the score image and the like projected above or on the keyboard may be changed and adjusted to a position easily visible to the player. The same is true for a fingering mark or an image of fingers.

According to the present invention, at least the measure to be played now and the measure to be played next of the upper and lower staves of a grand staff are displayed, and every time the measure to be played now is finished, the measure to be played next is displayed as a new measure to be played now. With this feature, the player may always see not only the notes contained in the measure to be played now, but also the notes in the measure to be played next while he plays.

According to the present invention, information about the position on the keyboard corresponding to each note in the upper and lower staves of a grand staff, and information about a distance between notes in the upper and lower staves are stored in advance, and the control means shifts the upper and lower staves in accordance with the stored information about the position on the keyboard and the information about the distance. With this feature, the control means may shift the upper and lower staves, when desired, so that the note to be played is located at a position on or above the key to be pressed corresponding to the note. Incidentally, as used herein, the term “information about a distance” means information for shifting the upper and lower staves displayed on the display means or information for adjusting the position or angle of the display means or the projecting means.

According to the present invention, the control means measures the time from causing display of the upper and lower staves until the pressed key detection means detects pressing of a key, and reflects the measured time to the play mode. With this feature, a play mode may be set automatically depending on the state of play of the player, so that the player may efficiently learn how to read and play a score.

According to the present invention, the control means synchronizes duration of notes in the upper and lower staves in the music data by the measure, and when a note in the upper staff is to be played simultaneously with a note in the lower staff, the control means proceeds with a subsequent process only when it acquires both of the notes via the pressed key detection means detecting corresponding keys. This feature allows the player to play the upper and lower staves in the music data in synchronization with each other, so that the player may efficiently learn how to read and play the upper and lower staves.

According to the present invention, the play assist device may be set to automatically play the upper or lower staff of the grand staff. With this feature, it is possible to set the lower staff to be played automatically when the player is to play only the upper staff, or to set the upper staff to be played automatically when the player is to play only the lower staff, so that the player may efficiently learn how to read and play the upper and lower staves.

According to the present invention, the control means synchronizes display of notes to be played simultaneously when the upper and lower staves contain notes of different values. This feature allows the player to play the upper and lower staves in synchronization, so that the player may efficiently learn how to read and play the upper and lower staves.

As discussed above, the play assist device according to the present invention comprises display means for displaying upper and lower staves of a grand staff independently by a predetermined range; projecting means for projecting images of the upper and lower staves of a grand staff above or onto a keyboard; pressed key detection means for detecting a pressed key; and control means for shifting the upper and lower staves so that a note to be played in the upper and lower staves is located at a position above or on the keyboard corresponding to the note. With this structure, according to music data containing information about notes and musical notation on the score of music to be played, the control means causes the display means to display a desired number of measures of the upper and lower staves of a grand staff, for example, two measures including the measure to be played now and the measure to be played next, and every time each measure is played, the display is renewed sequentially. The control means also determines whether or not to shift the upper and lower staves according to a play mode, wherein the conditions for shifting the upper and lower staves have been set up. When the control means decides to shift the upper and lower staves, it does so that the note to be played in the upper and lower staves is located at a position above or on the keyboard corresponding to the note. Thus the player may easily see the physical correspondence between the position of a note on the score shown on the display means and the position of a key of the keyboard to be actually pressed, which assists the player to clearly understand the positional relationship between the notes and the keys to be pressed. As a result, the player may efficiently learn how to read and play a score, and easily learn a skill to play from the score without relying on the play assist device.

### BRIEF DESCRIPTION OF THE DRAWINGS

FIG. 1 is a schematic perspective view of an embodiment of the play assist device according to the present invention, installed on a piano.

FIG. 2 is a schematic view illustrating the structure of the guide display in an embodiment of the present invention.

FIG. 3 is a schematic view illustrating the principle of the three-dimensional display in an embodiment of the present invention.

FIG. 4 is a schematic view showing an example of how three-dimensional display is made in the space above the keyboard according to an embodiment of the present invention.

FIG. 5 is a schematic view showing an example of how fingering marks are displayed according to an embodiment of the present invention.

FIG. 6 is a schematic view showing another example of how fingering marks are displayed according to another embodiment of the present invention.

FIG. 7 is a schematic view illustrating the principle of the hologram display according to an embodiment of the present invention.

FIG. 8 is a schematic view showing an example of how an image of fingers is holographically displayed according to an embodiment of the present invention.

FIG. 9 is a schematic view illustrating the principle of a toric lens in an embodiment of the present invention.

FIG. 10 is a schematic view showing an example of display on the keyboard surface using a toric lens according to an embodiment of the present invention.

FIG. 11 is a diagram illustrating the internal structure of an embodiment of the play assist device according to the present invention.

FIG. 12 shows the structure of the pressed key detection unit according to the present invention.

FIG. 13 is a schematic view of examples of a mechanism for shifting and adjusting the images of the upper and lower staves in accordance with information about a distance according to the present invention.

FIG. 14 shows an example of how to highlight the note to be played now according to the present invention.

FIG. 15 shows an example of how the images of the upper and lower staves are shifted according to the present invention.

FIG. 16 shows an example of how to display the note to be played and the actual key to be pressed in one-to-one correspondence for easy observation.

FIG. 17 shows an example of displaying a laterally expanded image of the score, with the note to be played and the key to be pressed in the middle.

FIG. 18 shows another example of how the images of the upper and lower staves are shifted according to the present invention.

FIG. 19 shows another example of displaying the score with a waveform.

### PREFERRED EMBODIMENTS OF THE INVENTION

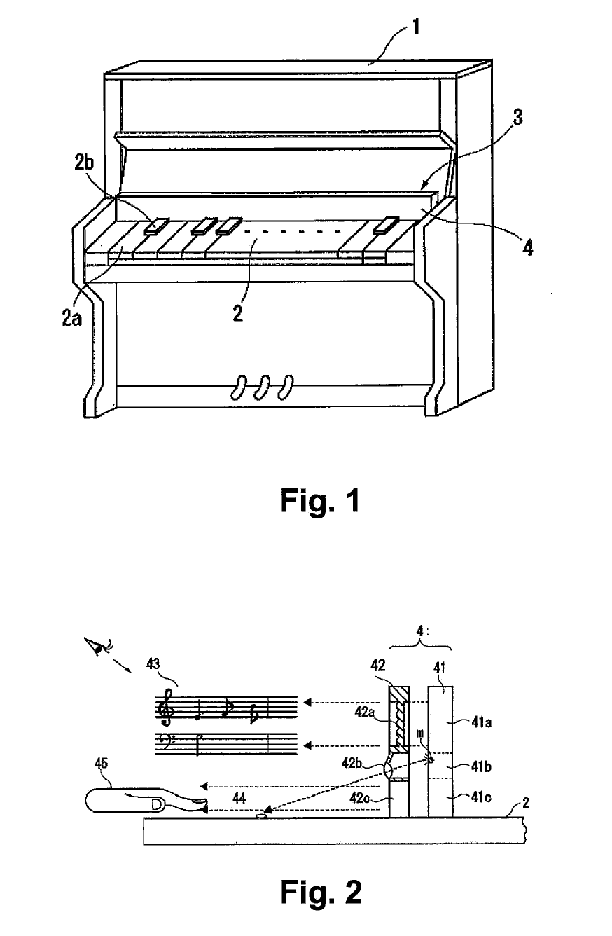

A first embodiment of the play assist device according to the present invention will be explained. Referring to FIG. 1, play assist device 3 is in the form of an elongate plate, and postinstalled along the keyboard 2 of piano 1 in place of or near a key presser positioned along the rear side of the keyboard 2. In this play assist device 3, guide display 4 having display means and projecting means, along with pressed key detection means and control means to be discussed later, are integrally attached to piano 1 in a detachable manner, so that the piano 1 or the keyboard 2 does not have to be processed. The play assist device 3 per se may be made in the form of a film by using an organic EL having built-in LSI and touch sensors. The play assist device 3 may be built into piano 1. The positions of the play assist device 3 and the guide display 4 are not limited to those shown in FIG. 1. A small enclosure accommodating the play assist device 3 and the guide display 4 may be placed on the top of or inside piano 1. A reflector plate may be used together with the play assist device 3, so that images of the upper and lower staves of a grand staff may be projected toward the keyboard 2. Incidentally, the play assist device 3, when used with a piano having a keyboard 2 with 88 keys, does not have to be provided for all of the 88 keys, and may be partially provided for a number of keys commonly used, such as 76, 64, or 49 keys.

FIG. 2 is a schematic view showing the structure of the guide display 4 of the present embodiment. Here, the image of a score and the like is displayed in three dimensions. The guide display 4, as shown in FIG. 2, is composed of dot matrix display 41 as means for displaying a score and the like, and lens plate 42 as projecting means arranged in front of the dot matrix display 41 for projecting the image of a score and the like displayed on the dot matrix display 41 into the space above the keyboard.

The dot matrix display 41 is vertically segmented into three areas, 41a, 41b, and 41c, with the first area 41a displaying a score, various messages, or the like, the second area 41b displaying fingering marks m, and the third area 41c displaying an image of fingers. The lens plate 42 is similarly segmented into fly's eye lens 42a corresponding to the first area 41a of the dot matrix display 41, single lens array 42b corresponding to the second area 41b, and space 42c corresponding to the third area 41c. In another embodiment, the lowermost third area 41c of the dot matrix display 41 and the lowermost space 42c of the lens plate 42 may be dispensed of. In yet another embodiment, the projecting means maybe provided corresponding to the second area 41b only, and not to the first area 41a. In addition, a position adjusting function may be provided for moving and adjusting the positions of the image of a score and the like, the fingering marks, or the image of fingers projected above the keyboard, into positions easily viewable to the player. The position adjusting function may include adjustments of the position or the angle of the dot matrix display 41 or the lens plate 42, and provided on either or both of these. A finger screw may be provided on either or both lateral ends of the dot matrix display 41 and/or lens plate 42, and the position and the angle of the dot matrix display 41 and/or the lens plate 42 may be adjusted by manipulating the screws. In this way, the image of a score and the like, the fingering marks, and the image of fingers projected above the keyboard may be moved and adjusted to a position viewable to the player, e.g., from the front to the rear of the keyboard 2 as seen by the player. Incidentally, the means for the three-dimensional display are not limited to the display means and the projecting means as discussed above, and may suitably be modified.

The score displayed in the first area 41a is a predetermined range of the upper staff (treble clef staff) and the lower staff (base clef staff) of a grand staff displayed independently from each other and in accordance with the music data stored in the memory of the play assist device 3. The music data includes note information, such as note values and tone pitch, and musical notation information, such as rhythm and sound intensity, which are obtained by loading the upper staff (treble clef staff) and the lower staff (base clef staff) of an original grand staff as image data, and matching the notes, musical notation, and the like shown in the loaded image data. At least the measure to be played now and the measure to be played next of the upper and lower staves are shown, and every time the measure to be played now is finished, the measure to be played next is shown as a new measure to be played now. In this way, the player may visually observe not only the notes contained in the measure to be played now, but also the notes in the measure to be played next, while he plays. In addition, a measure having played in the past of the upper and lower staves may also be displayed. In this way, the player may also visually observe a measure having played in the past. The fly's eye lens 42a of the lens plate 42 corresponds to the first area 41a, and the two together form a three-dimensional display which forms, above the keyboard 2, a virtual stereo image 43, such as an image of the notes and the like displayed in the first area 41a.

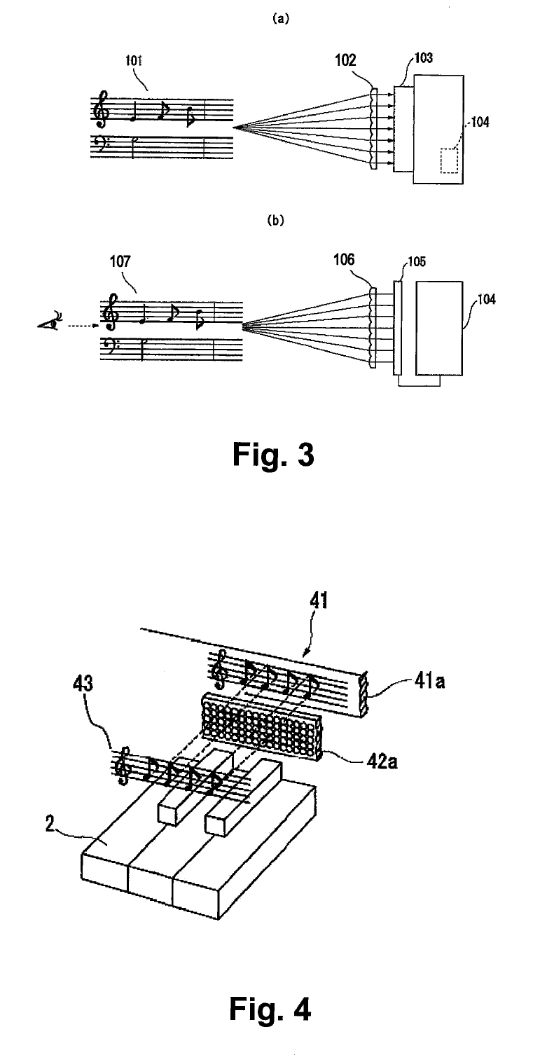

FIG. 3 illustrates a basic principle of integral photography (IP) as an example of a three-dimensional display. As shown in FIG. 3(a), a multitude of small image data of physical object 101 is captured by a CCD camera 103 through a fly's eye lens 102, which is composed of arrays of micro convex lenses, and stored in a memory 104. Upon reproduction, as shown in FIG. 3(b), the image data is transmitted from the memory 104 to a liquid crystal display 105, on which the small image data are displayed. When you see from the front of the display 105 through a fly's eye lens 106 similar to the fly's eye lens 102, a reproduced stereo image 107 of the physical object is observed. For three-dimensional display, other than the integral photography, conventional technologies may be employed, such as parallax barrier technology, which utilizes images formed by alternately synthesizing vertically divided, right and left parallax images in stripes, or lenticular lens technology. In this regard, part of the lens plate 42 may suitably be modified for the parallax barrier technology.

In this way, image data of the upper and lower staves of a grand staff to be displayed in the first area 41a is respectively formed, for example, in advance by the measure, associated with music data containing information about the value and pitch of each note on the score and information about musical notation, such as rhythm and intensity, and stored in a memory. The stored image data is suitably selected via a liquid crystal driver, and displayed in the first area 41a of the dot matrix display 41 as shown in FIG. 4, so that its virtual stereo image 43 is displayed above the keyboard 2. While he is playing, the player may see the upper and lower staff images at the same time as he looks in the direction of the keyboard 2. Incidentally, the image data of the upper and lower staves of a grand staff may be used for displaying digital images or digital characters showing the upper and lower staves of a grand staff in the first area 41a of the dot matrix display 41 as a digital display.

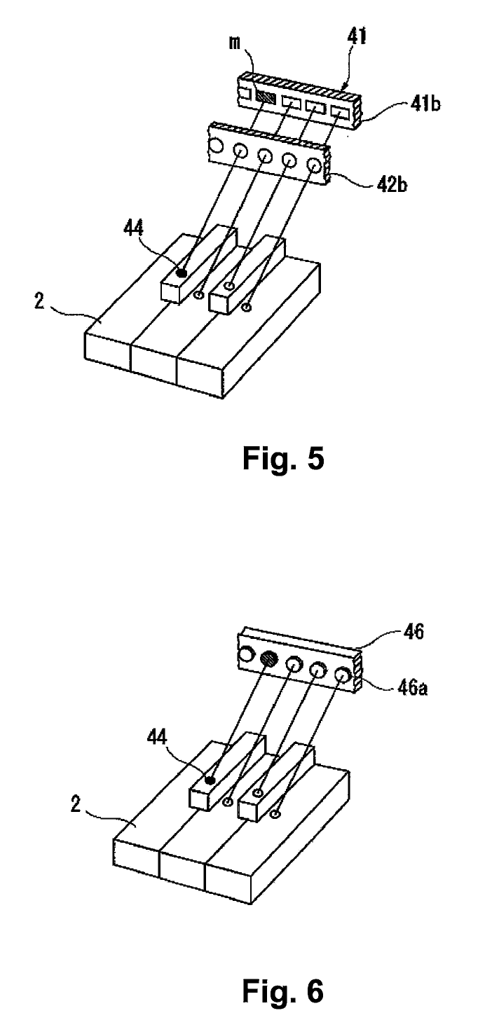

The fingering mark m displayed in the second area 41b of the dot matrix display 41 is displayed correspondingly at a position of the key to be pressed as shown in FIG. 5. The single lens array 42b of the lens plate 42 corresponding to the second area 41b produces an image of the fingering mark m displayed in the second area 41b as a beam spot 44 on the keyboard 2. The fingering mark m does not have to be a beam spot 44 as shown in the figures, but may be a numeral 1 to 5 assigned to each finger. The fingering mark m is correspondingly displayed at the key to be pressed now, in accordance with the information about the value and the pitch of each note and the musical notation, such as rhythm and intensity, included in the music data stored in the memory of the play assist device 3.

Alternatively, the second area 41b does not have to be configured as part of the dot matrix display 41, but may be formed as LED array 46 as shown in FIG. 6, which includes LEDs 46a arranged in a row at positions corresponding to the keys of the keyboard 2, and each emitting light onto the surface of a key of the keyboard 2 as beam spot 44. In this case, the LED array 46 may be arranged in the second area 41b, with the area of the single lens array 42b being a blank space, or may be arranged in the area of the single lens array 42b, with the second area 41b being a blank or dead space. Further, the LEDs 46a may be replaced with laser diodes to form a semiconductor laser array.

Referring to FIG. 2, the third area 41c, with the corresponding area of the lens plate 42 being an open space 42c, constitutes a hologram display which forms, above the keyboard 2, a reproduced stereo image 45 of the finger image displayed in the third area 41c. The reproduced stereo image 45 of the finger image may be adjusted so that, when viewed from the above, the five fingers of each of the right and left hands are displayed at intervals approximately equal to the width of the keys.

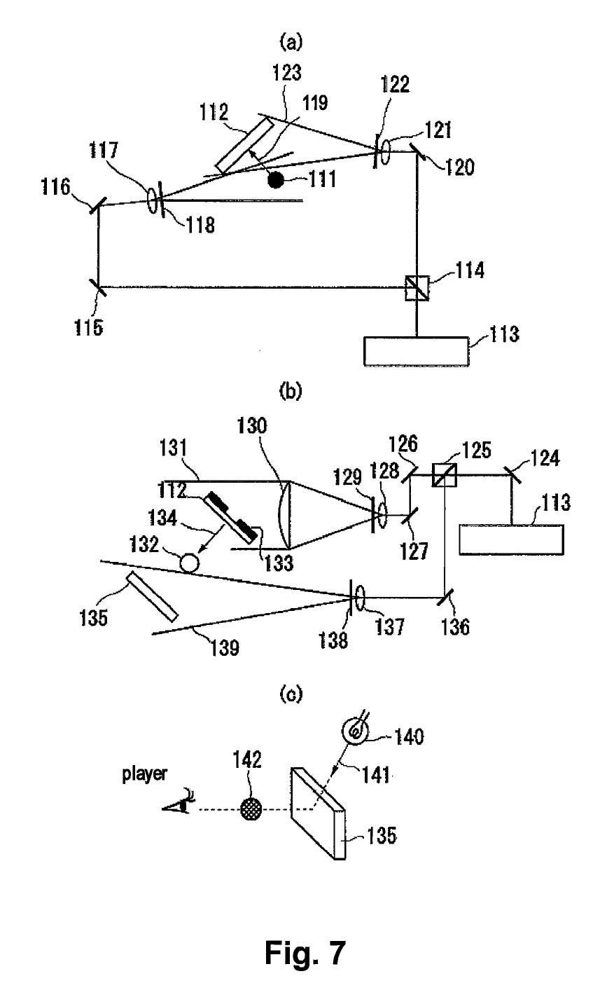

FIG. 7 illustrates the principle of the rainbow hologram technique when used as a hologram display in an embodiment of the present invention. Referring to FIG. 7(a), in order to record object 111 on master hologram plate 112, laser beam emitted from He—Ne laser 113 is reflected by beam splitter 114 and mirrors 115, 116, and diverged by objective lens 117 and pinhole 118 to illuminate the object 11. The light reflected from the object 111, i.e., object beam 119, is casted on the master hologram plate 112. On the other hand, the laser beam passed through the beam splitter 114 is reflected by mirror 120, diverged by objective lens 121 and pinhole 122, and casted on the master hologram plate 112 as reference beam 123. In this way, the object beam 119 and the reference beam 123 form an interference pattern on the master hologram plate 112 to produce master hologram. Next, referring to FIG. 7(b), laser beam from the same He—Ne laser 113 is reflected by mirror 124, beam splitter 125, and mirrors 126, 127, diverged by objective lens 128 and pinhole 129, and converted by collimator lens 130 into parallel reproducing illumination beam 131. The reproducing illumination beam 131 is casted onto the master hologram plate 112 from the direction opposite to the reference beam 123 mentioned above. In this way, reproduced real image 132 is generated on the side of the master hologram plate 112 opposite from the object 111. Slit plate 133 is disposed on the surface of the master hologram plate 112 on the side of the collimator lens 130, and the light passing through the slit plate 133 illuminates the reproduced real image 132 as object beam 134 casting onto transfer hologram plate 135. On the other hand, the laser beam reflected by the beam splitter 125 is reflected by mirror 136, diverged by objective lens 137 and pinhole 138, and casted onto the transfer hologram plate 135 as reference beam 139. In this way, the object beam 134 and the reference beam 139 form an interference pattern on the transfer hologram plate 135 to produce transfer hologram. For reproduction, as shown in FIG. 7(c), the transfer hologram plate 135 on which the interference pattern has been formed is illuminated with reproducing illumination light 141 from white light source 140 on the side of the plate 135 opposite from the viewer in the direction opposite to the reference beam 139, so that reproduced real image 142 is formed on the side opposite from the white light source 140, and the viewer can observe this image 142.

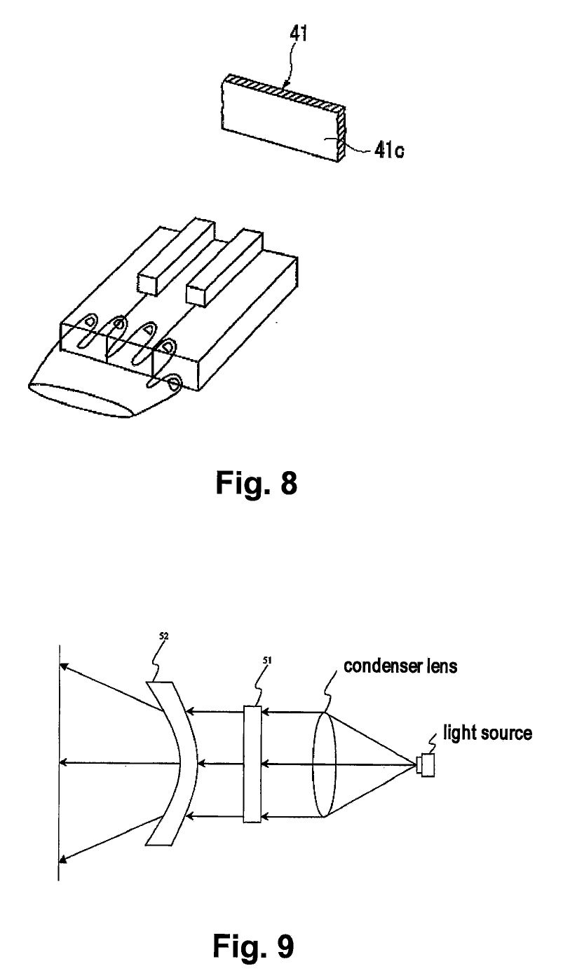

A hologram display utilizing this rainbow hologram technique according to an embodiment of the present invention will be discussed. First, a master hologram is produced by capturing, by means of a CCD camera as the master hologram plate 112 in FIG. 7(a), an image of fingers as the object 111, which is to be arranged at a position on the keyboard corresponding to the notes on the score, and storing the resulting interference pattern of the fingers in a memory of a computer connected to the CCD camera. Then, the interference pattern stored in the memory of the computer is output to a transmissive liquid crystal display connected to the computer as the master hologram plate 112 in FIG. 7(b), to generate the reproduced real image 132. In front of the master hologram plate 112, a CCD camera connected to the computer is positioned as the transfer hologram plate 135, and the reproduced real image 132 is captured by this CCD camera and stored in the memory of the computer. In the third area 41c of the guide display 4 to be actually mounted on a piano, a transmissive LCD is used in place of the transfer hologram plate 135 in FIG. 7(c). The interference pattern stored in the memory of the computer is output to the transmissive LCD, which is illuminated with white light as the reproducing illumination light 141 from an LED or the like as the white light source 140 located behind, to thereby generate the reproduced real image 142 on the side of the player. In the space above the keyboard 2, as shown in FIG. 8, a reproduced stereo image 45 of fingers arranged at a position on the keyboard which corresponds to the notes on the score. In this way, the image of fingers is correspondingly displayed at the key to be pressed now, in accordance with information about the value and the pitch of the notes and the musical notation, such as rhythm and intensity, included in the music data stored in the memory of the play assist device 3. Aside from the rainbow hologram, other conventional hologram techniques may be employed for reproducing a reproduced stereo image toward the keyboard 2. Further, correction of refraction or diffraction efficiency using hologram optical elements (HOE) will result in still improved hologram images. Incidentally, the image data of fingers may be used for displaying a digital image of fingers in the first area 41a of the dot matrix display 41 as a digital display.

The guide display 4 is configured as discussed above. In the above discussion, the score displayed in the first area 41a has been explained as being displayed in three dimensions, but two dimensional display may also be conceivable. For example, an image of the upper and lower staves of a grand staff may be displayed in two dimensions by providing a small sized dot matrix display of high integration density having dots at least comparable in number to those of the first area 41a of the dot matrix display 41, and providing, as shown in FIG. 9, transmissive LCD 51 on which the upper and lower staves of a grand staff is displayed and a toric lens 52 in front of the LCD 51 for projecting the image of the upper and lower staves of a grand staff displayed on the transmissive LCD 51 onto the surface of the keyboard. As a light source for the transmissive LCD 51, incandescent bulbs, fluorescent tubes, cold-cathode tubes, light emitting diodes (LEDs), laser diodes (LDs), or the like may be used. The toric lens, which has a refracting surface of a configuration of a bent cylindrical lens, has different refracting surface positions depending on the length of light paths, so that, when an image from the transmissive LCD is projected onto the keyboard in a planar and linear manner, the image is entirely in focus and may be projected in a planar manner. A reproduced image of a physical object (here the fingers) may be obtained by capturing image data of the physical object by a CCD camera through the toric lens 52, storing the image data in a memory, transmitting the image data from the memory to the transmissive LCD 51 for reproduction, displaying the image data on the transmissive LCD 51, and projecting the image through the toric lens 52.

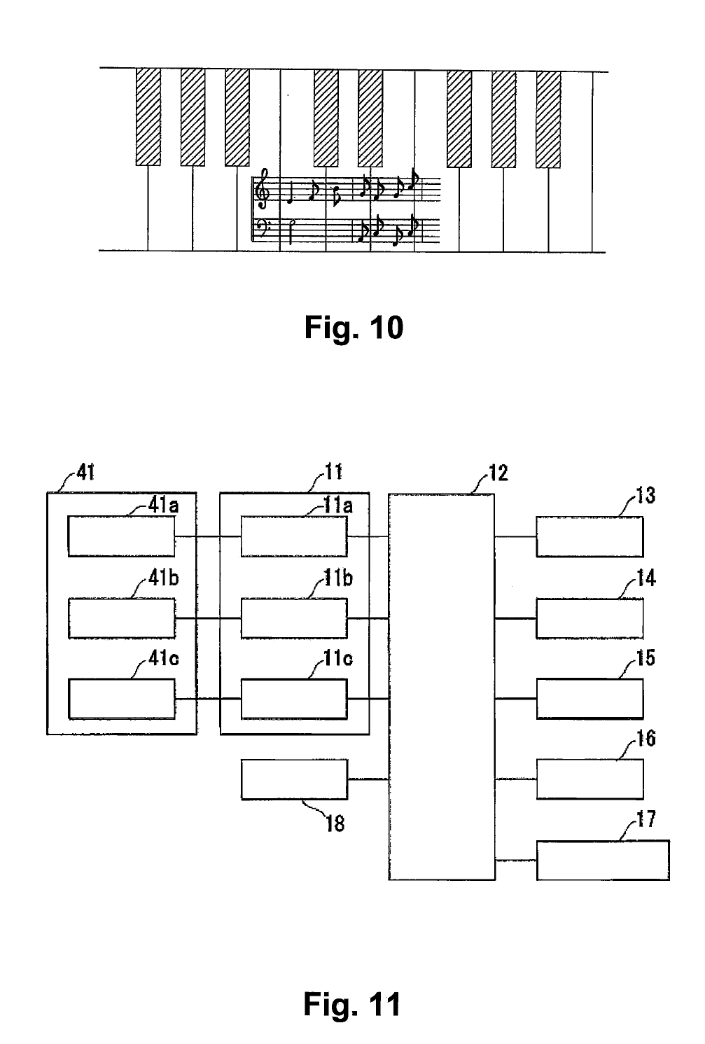

In this way, the image data of the upper and lower staves of a grand staff is respectively formed, for example, in advance by the measure, and stored in a memory. The stored image data is suitably selected via a liquid crystal driver, displayed on the transmissive LCD 51, and projected through the toric lens 52, so that the reproduced image is displayed in two dimensions the keyboard 2 as shown in FIG. 10. Incidentally, for two-dimensional display, in a similar manner as in the above, a position adjusting function may be provided on either or both of the transmissive LCD 51 and the toric lens 52 for adjusting the position or angle thereof. A finger screw may be provided on either or both lateral ends of the transmissive LCD 51 or toric lens 52, and the position and the angle of the transmissive LCD 51 or toric lens 52 may be adjusted by manipulating the screws. In this way, the image of a score and the like, the fingering marks, and the image of fingers projected onto the keyboard surface may be moved and adjusted to a position viewable to the player, i.e., from the front to the rear of the keyboard 2 as seen by the player. The embodiment of the two-dimensional display is not limited to the display means and projection means discussed above, and may suitably be modified.

FIG. 11 shows the internal constitution of the play assist device 3 according to the present embodiment. Referring to FIG. 11, the first area 41a of the dot matrix display 41 is driven by first drive 11a of liquid crystal drive (LCD driver) 11, and the second area 41b by second drive 11b, and the third area 41c by third drive 11c. The drives 11a, 11b, and 11c of the LCD driver 11 are controlled by control unit 12, which is a CPU. Connected to the control unit 12 are ROM 13 which stores the OS for control of the overall device by the control unit 12 and application programs for control of the play assist device 3; RAM 14 which temporarily stores music data used by the control unit 12 for control of each unit, including information about the value and the pitch of each note on the score and information about musical notation, such as rhythm and sound intensity, as well as respective image data of the upper and lower staves and image data of fingers, which are associated with the music data and to be displayed on the dot matrix display 41, and data of tasks being processed by the control unit 12; external memory 15, such as an IC card, optical card, optical disk, magnetic card, or magnetic disk, for storing the music data, respective image data of the upper and lower staves, and image data of fingers; pressed key detection unit 16 for detecting key-pressing or key-releasing action of the player; state-of-play determination unit 17 which determines the state of play by comparing the play data of the player obtained from the key-pressing/releasing action detected by the pressed key detection unit 16 with the music data loaded from the external memory 15 to the RAM 14; and operation input unit 18 for inputting a play mode including the level at which the player plays, the conditions for proceeding with the music data, the conditions for shifting the score image, and the like. The control unit 12 may be provided with an interface function for data processed to and from DVD or hard disk as a memory device, or personal computer, MIDI, or other terminals. The ROM 13 and RAM 14 may be replaced with flash memories.

The external memory 15 stores music data as discussed above. The music data has been created in accordance with the value and pitch of each note on a score of a piece to be played by a player, rhythm and sound intensity according to each musical notation, and the like. When being stored, the music data is associated with respective image data of the upper and lower staves and image data of fingers to be displayed on the dot matrix display 41. In this way, the image data of the respective upper and lower staves and the image data of fingers may be displayed in synchronization with the progress of the music data.

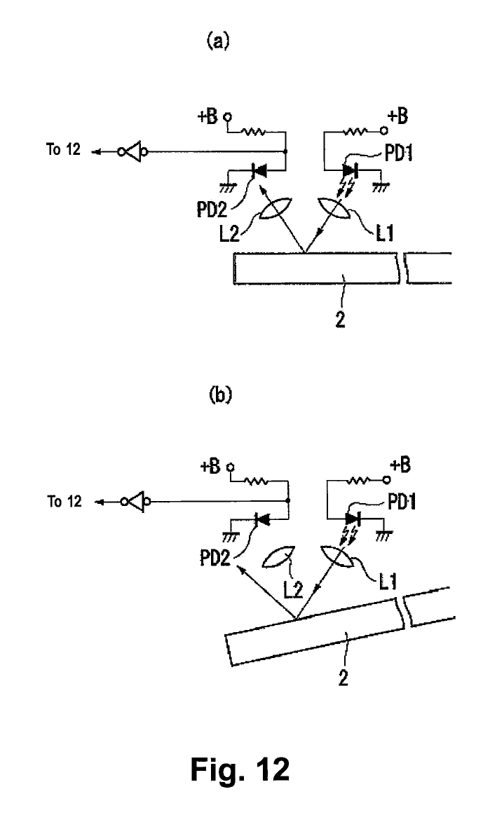

In the pressed key detection unit 16, a transmission or reflective photocoupler is used to detect positional displacement of a pressed key, to thereby detect pressing and/or releasing of a key. FIG. 12 shows an embodiment utilizing a reflective photocoupler. As shown in FIG. 12(a), the photocoupler includes light-emitting diode PD1 and light-receiving diode PD2. Before key 2 is pressed down with a finger, the light beam emitted from the light-emitting diode PD1 is received by the light-receiving diode PD2 through lenses L1 and L2, and the electric current from power supply +B is earthed via the light-receiving diode PD2, so that a pressed key signal is not output to the control unit 12. When key 2 is pressed down, as shown in FIG. 12(b), the light beam emitted from the light-emitting diode PD1 is no longer received by the light-receiving diode PD2, and the electric current from power supply +B is output to the control unit 12 as a pressed key signal in the form of a voltage signal, so that the pressed key 2 is detected. When the key 2 is released from the state shown in FIG. 12(b), the photocoupler returns to the state shown in FIG. 12(a), wherein the electric current is flown to the light-receiving diode PD2 and the control unit 12 detects that the key has been released. That is, every time the player presses or releases a key, the pressed key detection unit 16 detects the pressing or releasing of the key, and outputs a pressed key detection signal to the control unit 12. Alternatively, the pressed key detection unit 16 may detect a pressed key by frequency obtained by fast Fourier transformation (FFT). For example, the sound made by pressing a key is collected with a microphone and A/D converted, the duration of a series of sound waveform and the number of samples are determined, and the frequency is determined using discrete Fourier transform, so that key 2 corresponding to the frequency is identified. Not only for a single note, but also for a code or polyphony included in music data, the frequency of each note may be obtained by using Mathmatica (registered trademark) and the like, so that each key 2 corresponding to each frequency may be identified.

The state-of-play determination unit 17 acquires play data, such as the position of a key 2 pressed by the player (sound pitch), the duration of sound from pressing to release of a key (note value), rhythm, intensity, and the like, via the pressed key detection signal obtained by the control unit 12, and compares the acquired play data with the music data acquired from the RAM 14 through the control unit 12, to thereby determine the state of playas needed. The result of the determination is sent to the control unit 12, and when, for example, the play data is faster than the music data, the control unit 12 causes the first area 41a of the dot matrix display 41 to display “PLAY MORE SLOWLY” or the like for notification to the player.

The operation input unit 18 designates a play mode and instructs what is to be displayed, through a mouse, trackball, pad, or keyboard. The operation input unit 18 may be provided on the front surface of the dot matrix display 41 as a touch panel on which a player may write with a light pen and/or a finger. The play mode sets the processing to be done by the control unit 12 according to a play level, and includes the predetermined conditions for proceeding with the music data, shifting the upper and lower staves, and the like. The control unit 12 determines the progress of the music data and the shift of the upper and lower staves, according to the established play mode. For example, a play mode for advanced players is set so that the control unit 12 sequentially proceeds with the music data independent of the play state determined by the state-of-play determination unit 17, and the upper and lower staves are not shifted. A play mode for intermediate players is set so that the music data sequentially proceeds except when the state of play determined by the state-of-play determination unit 17 indicates that the player does not press a key even after the lapse of the time designated by a note in the music data or of a predetermined time period, or the player presses a wrong key, and when the player does not press a key even after the lapse of the time designated by a note in the music data or of a predetermined time period, or the player presses a wrong key, the upper and lower staves are shifted so that the note to be played is positioned on or near the corresponding key. A play mode for beginners is set so that the music data sequentially proceeds except when the state of play determined by the state-of-play determination unit 17 indicates that the player does not press a key even after the lapse of the time designated by a note in the music data or of a predetermined time period, or the player presses a wrong key, and the upper and lower staves are shifted so that the note to be played is always positioned on or near the corresponding key.

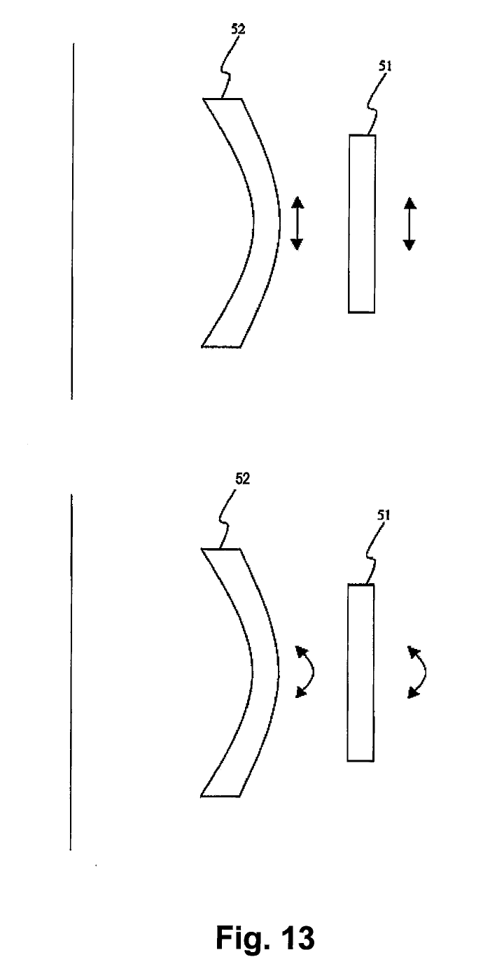

The control unit 12 shifts the upper and lower staves, when desired, so that the note to be played is positioned above or on the corresponding key. In order for the control unit 12 to process the shift, the external memory 15 stores in advance information about the position of a key corresponding to each note and the distance between adjacent notes in the music data. For example, when the music data contains notes “D”, “F”, and “E” in this order, the information about the key position is stored in numerals, i.e., “2”, “4”, and “3”, and the information about the distance between adjacent notes is stored as a difference between the positional information of the adjacent notes, i.e., “+2” and “−1”. In this way, the upper and lower staves may be shifted, when desired, by the control unit 12, so that the note to be played is positioned above or on the corresponding key. In addition, the external memory 15 stores in advance information about the position of a key corresponding to the pitch. For example, according to the pitches “C, D, E, F, G, A, B, C”, information about the key positions is stored in numerals, i.e., “1, 2, 3, 4, 5, 6, 7, 8”. The control unit 12 may acquire information about the distance between notes in the upper and lower staves from the difference between the pitch of the note currently being played (e.g., “4” for F) and the pitch of the note to be played next (“3” for E) (the difference being “−1”) or the pitch of the note previously played (“2” for D) (the difference being “+2”). In this way, the upper and lower staves may be shifted by the control unit 12, when desired, so that the note to be played is positioned above or on the corresponding key. Incidentally, as used herein, the information about the distance means information for shifting the upper and lower staves displayed on the dot matrix display 41 or for adjusting the position and angle of the dot matrix display 41 and the lens plate 42. The control unit 12 inputs the information about the distance to the liquid crystal drive 11, by which the latter drives shift of the image data of the upper and lower staves displayed on the dot matrix display 41, or adjustment of the position and angle of both or either of the dot matrix display 41 (or the transmissive LCD 51) and the lens plate 42 (or the toric lens 52) (see FIG. 13).

Next, specific examples of the play assistance using the play assist device 3 of the present invention will be explained for each play level. According to the present embodiment, the player may arbitrarily choose via the operation input unit 18 a play mode from Level 1 to Level 5 as follows, according to the skill of the player.

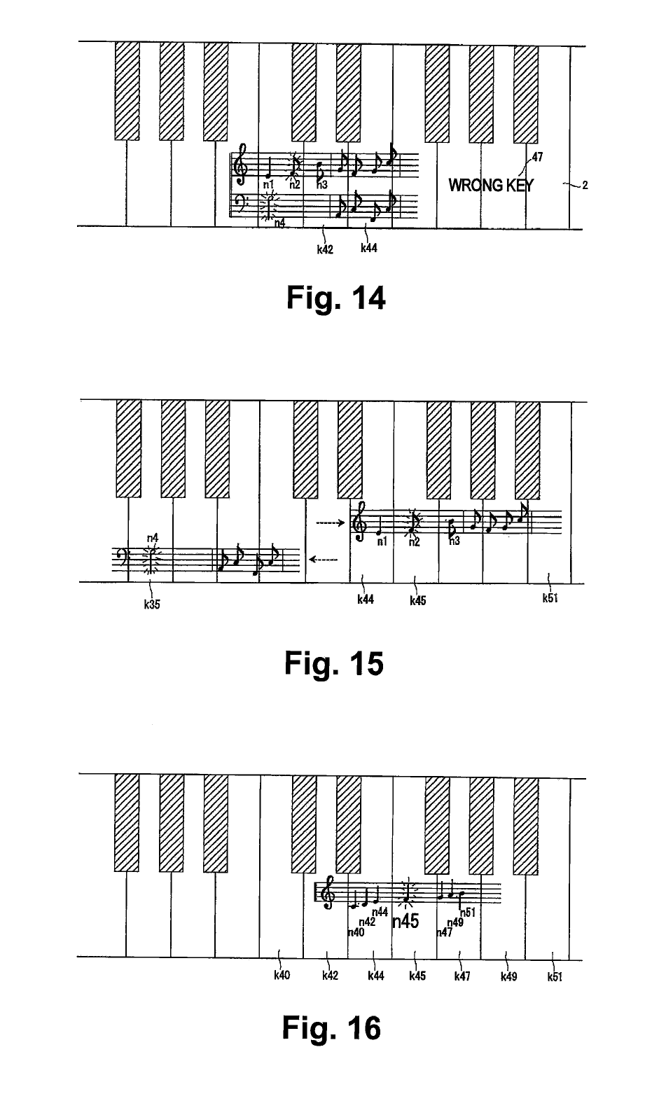

Level 1: Level 1 is for advanced players. The first area 41a sequentially displays the upper and lower staves of a grand staff by an arbitrary number of measures, e.g. by two measures, and the image thereof is projected onto the display position corresponding to the space above or the surface of the keyboard 2 in the approximate center thereof. As means for highlighting the note to be played now, aside from the blinking display as shown in FIG. 14, enlarged display, rotational display, reversed display, vibrating display, around-the-note radiant display, background-color-change display, or the like may be used. In this Level 1, when the player presses a key, irrespective of whether it is a correct key as shown on the score or a wrong key, the next note is sequentially displayed with highlight. However, when the player presses a wrong key, a note corresponding to the pitch of the pressed key detected by the pressed key detection unit 16 is displayed at a corresponding pitch position on the score displayed on the first area 41a, and message 47, such as “WRONG KEY”, may be displayed. For example, if the player presses key k42 when he is supposed to press key k44 corresponding to note n1, a note corresponding to key k42 is displayed in red at the pitch position of the note, i.e., “D”. In this way, the player can clearly recognizes that he pressed a wrong key, and understands the relationship between the erroneously pressed key and the position thereof on the score, which improves his score-reading ability. Alternatively, this display of a note may be made by displaying an x-mark or only a note head at the relevant pitch position. The value of a note may be displayed corresponding to the duration of a key being pressed, i.e., the time from pressing to releasing of a key detected by the pressed key detection unit 16. The pitch position of the erroneously pressed key may be stored in the RAM 14, and displayed after the play so that the player may reconfirm his mistake. This wrong key display function is applied also to Levels 2 to 5 to be discussed later.

Level 2: Level 2 is for intermediate players, and is applied when the player does not press a key even after the lapse of the time designated by a note in the music data or of a predetermined time period, or the player presses a wrong key. In this Level 2, an image of a grand staff is initially displayed at the display position in approximately the center of the keyboard 2 as in Level 1. When the player does not press a key even after the lapse of a predetermined time period, or the player presses a wrong key, the image of the upper staff is shifted to near the position of the key supposed to be pressed with a right hand finger, and the lower staff near the position of the key supposed to be pressed with a left hand finger. That is, the approximate position of the key to be pressed is shown to the player so that he could confirm which key is to be pressed. Here, the distance between the notes in the image of the upper and/or lower staff may be made smaller than the width of a key to be pressed so that a plurality of notes are shown within the width. In this way, the player may be given an opportunity to think which note corresponds to which key, which improves his score reading ability.

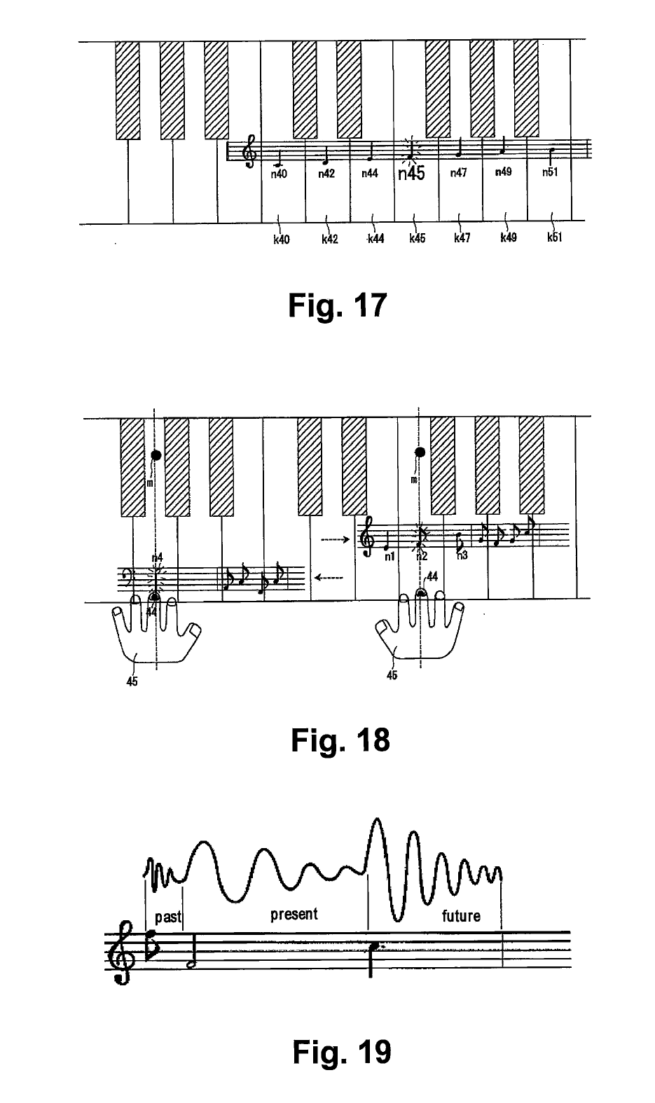

Level 3: Level 3 is for intermediate players lower than Level 2, and is applied when the player does not press the key corresponding to the note to be played even after the lapse of the designated time or of a predetermined time period, or the player presses a wrong key. In this Level 3, an image of a grand staff is initially displayed at the display position in approximately the center of the keyboard 2 as in Level 1. When the player does not press a key even after the lapse of a predetermined time period, or the player presses a wrong key, the image of the upper staff is shifted to the key corresponding to the note supposed to be played with a right hand finger, and the lower staff to the key corresponding to the note supposed to be played with a left hand finger, as shown in FIG. 15. That is, if the key corresponding to note n4 supposed to be played with a left hand finger is not pressed correctly, the entire image of the lower staff is shifted to the left so that the note n4 is positioned at key k35 to be pressed. If the key corresponding to note n2 supposed to be played with a right hand finger is not pressed correctly, the entire image of the upper staff is shifted to the right so that the note n2 is positioned at key k45 to be pressed. Here, the distance between the note to be played and the adjacent notes on its left and right in the image of the upper and/or lower staff is made approximately equal to the width of the actual key to be pressed as shown in FIG. 16 so that the note to be played is shown in one-to-one correspondence with the key to be pressed for easy observation. This does not apply to the distance between the notes not to be played. In this way, the note to be played actually is highlighted while the notes not to be played are shown close to the actual score, which provides training in score reading. As an alternative manner, as shown in FIG. 17, in order for every key supposed to be pressed in one measure to correspond one-to-one with each note, the overall image of the score may be expanded laterally, with the note n45 to be played now and the key k45 to be pressed being in the center so that note n40 corresponds to key 40, note n42 to key k42, note n44 to key k44, and so on. This provides easy-to-follow display, but when the player has adjusted himself to some extent, the display is better to be switched to the one as shown in FIG. 16. When the player presses a correct key, the upper and/or lower staff is returned to the initial central display position. In this way, the player can visually observe and understand easily the correspondence between the note to be played and the key to be pressed.

Level 4: Level 4 is for beginners lower than Level 3, and is applied when the player does not press a key even after the lapse of the time designated by a note in the music data or of a predetermined time period, or the player presses a wrong key. In this Level 4, an image of a grand staff is initially displayed at the display position in approximately the center of the keyboard 2 as in Level 1. When the player does not press a key even after the lapse of a predetermined time period, or the player presses a wrong key, the image of the upper staff is shifted to the key corresponding to the note supposed to be played with a right hand finger, and the lower staff to the key corresponding to the note supposed to be played with a left hand finger, as shown in FIG. 18. That is, if the key corresponding to note n4 supposed to be played with a left hand finger is not pressed correctly, the entire image of the lower staff is shifted to the left so that the note n4 is positioned at key k35 to be pressed. If the key corresponding to note n2 supposed to be played with a right hand finger is not pressed correctly, the entire image of the upper staff is shifted to the right so that the note n2 is positioned at key k47 to be pressed. Here, as discussed above, the distance between the note to be played and the adjacent notes on its left and right in the image of the upper and/or lower staff is made approximately equal to the width of the actual key to be pressed so that the note to be played is shown in one-to-one correspondence with the key to be pressed for easy observation. This does not apply to the distance between the notes not to be played. Further, fingering marks m are displayed in the second area 41b at positions corresponding to the keys k35 and k47 to be pressed to project beam spots 44 onto the keys k35 and k47. An image of fingers is displayed in hologram in the third area 41c to display a reproduced stereo image 45 of the image of fingers at a corresponding position on the keyboard 2 so that the fingers to be used correspond to the keys to be pressed. The fingers not in use are also displayed together, so that the change in space between the fingers according to the fingering may be visually observed at a glance. In this way, the player can visually observe and understand easily the correspondence among the note to be played, the key to be pressed, and the finger to be used. The images of the right and left hand fingers may be displayed in different colors according to the music data for easy distinction from each other. The finger to be used may be displayed in a color different from that of the other fingers according to the music data, and flapped up and down above the key to be pressed, which provides very easy observation to the player. For example, the left hand may be displayed in pink and the right hand in pale blue, with a left hand finger to be used being displayed in red and a right hand finger to be used in blue. The display may be made different from the normal display in case of cross under (the thumb moves under the other fingers) or cross over (the thumb is crossed over by the other fingers), e.g., only the thumb may be flapped or blinked, which assists the player to learn accurate fingering. Further, in accordance with the progress of the music data, the player may be notified in advance lateral shift of hands. When the player presses a correct key, the image of the upper and/or lower staff is returned to the initial center display position. In this way, the player can visually observe and understand easily the correspondence between the note to be played and the key to be pressed. Incidentally, in order for every note to correspond one-to-one with each key to be pressed, the overall image of the score may be expanded laterally so that, for example, note n1 corresponds to key k44, note n2 to key k47, and note n3 to key k51.

Level 5: Level 5 is for beginners still lower than Level 4. From the start of the play, as shown in FIG. 15, the image of the upper staff is shifted to the key corresponding to the note to be played with the right hand, and the image of the lower staff to the position corresponding to the note to be played with the left hand. Fingering marks m are displayed in the second area 41b at positions corresponding to the keys k35 and k47 to be pressed to project beam spots 44 onto the keys k35 and k47. An image of fingers is displayed in hologram in the third area 41c to display a reproduced stereo image 45 of the image of fingers at a corresponding position on the keyboard 2 so that the finger to be used corresponds to the key to be pressed. In this way, the player can visually observe and understand easily the correspondence among the note to be played, the key to be pressed, and the finger to be used. The images of the right and left hands may be displayed in different colors according to the music data for easy distinction from each other. Further, in accordance with the progress of the music data, the player may be notified in advance lateral shift of hands.

The player chooses one of the play modes of Levels 1 to 5 discussed above at the start of his play, but may change the mode even in the middle of the play. The control unit 12 may measure the time from causing display of the upper and lower staves until the pressed key detection unit 16 detects the key, and reflect the measured time to the play mode. That is, the play mode may be set and changed automatically in accordance with the state of play of the player. For example, in accordance with the state of play of the player, the play mode may be changed automatically from Level 1 through Level 2 to Level 3. In this way, the player may efficiently learn how to read and play a score. Incidentally, in this embodiment of the present invention, for the sake of convenience in explanation, the play level has been graded in five stages for the discussion of the set up of the conditions for the progress of music data or shift of the upper and lower staves. However, more detailed, various conditions may be set. For example, it is conceivable to set the conditions so that the player plays only the upper or lower staff. When the player plays only the upper staff, the lower staff may be set to be played automatically, whereas when the player plays only the lower staff, the upper staff may be set to be played automatically. In a lower level, it is conceivable to set the conditions so as to be switched to automatic playing to automatically conform to the progress of music data.

It may be made optional to return the image of a score to the initial, central display position when the player presses a correct key. In displaying a score in the first area 41a, the measure currently being played may be displayed in color, and the background color of the measure may be changed sequentially according to the progress of the notes, while the changing color may blink to the tempo represented by a metronome marking, so that the player may feel the tempo of the music. When a plurality of notes are highlighted to play, i.e., in case of a chord or polyphony, the correspondence between the highlighted notes and the actual keys to be pressed may be indicated so that the highlighted notes stay above a key most suitable for fingering. For example, when the music data contains notes representing a chord or polyphony, it is preferred to configure the settings so that each of the notes is displayed at its corresponding key. The control unit 12 may synchronize the duration of notes in the upper and lower staves by the measure, and when a note in the upper staff is supposed to be played simultaneously with a note in the lower staff, the control unit 12 proceeds with the subsequent process only when it acquires both of the notes via the pressed key detection unit 16 detecting the corresponding keys. This allows the player to play the upper and lower staves in the music data in synchronization with each other, to learn efficiently how to read and play the upper and lower staves. In other words, the upper and lower staves in the music data are set to synchronize for each measure, and when certain notes in the music data are supposed to be played with the right and left hands simultaneously, the control unit 12 takes it as an error to press only a key corresponding to the note in the upper staff or to press only a key corresponding to the note in the lower staff. Only when both of the notes are acquired via the pressed key detection unit 16 detecting the corresponding keys, the control unit 12 proceeds with the subsequent process. In this way, the music data may proceed, with the upper and lower staves in synchronization with each other for each measure, and the player may learn efficiently how to read and play the upper and lower staves. In the score displayed in the first area 41a, the order of the notes to be played may be indicated based on the information about the notes and the musical notation in the music data. In this way, the player by himself may play the upper and lower staves in synchronization with each other, and efficiently learn how to read and play a score. As shown in FIG. 19, a waveform may be displayed in the first area 41a above (or below) the display of a score, in which the sound intensity is indicated by amplitude, the pitch by frequency, and the note value by duration. By showing the waveform of the note to be played now in a kind of line or a color different from that of the waveform of the previous or subsequent note, the player may visually understand the intensity, pitch, and duration of a note.

As discussed above, with this embodiment, according to the music data containing information about notes and musical notation in the piece of music to be played, the display means displays a desired number of measures of the upper and lower staves of a grand staff, for example, two measures including the measure to be played now and the measure to be played next, and every time each measure is played, the display is renewed sequentially. It is determined whether or not to shift the upper and lower staves according to the play mode, wherein the conditions for shifting the upper and lower staves are established. The upper and lower staves are shifted, when desired, so that the note to be played is located at a corresponding position above or on the keyboard. Thus, the player may easily see the physical correspondence between the position of a note on the score shown on the display means and the position of a key of the keyboard to be actually pressed, which assists the player to clearly understand the positional relationship between the notes and the keys to be pressed. As a result, the player may efficiently learn how to read and play a score, and easily learn a skill to play from the score without relying on the play assist device. In accordance with the progress of the music data, after the pressed key detection unit 16 detects the key-pressing motion of the player, the position of the key supposed to be pressed next may be indicated sequentially with a fingering mark m and an image of fingers. Since such guiding indications are projected onto the corresponding key by means of the lens plate 42 arranged in the front, the player may see the keyboard to play with correct fingering. By comparing the play data detected by the pressed key detection unit 16 and the corresponding music data stored in the RAM 14, the state-of-play determination unit 17 can determine the state of play of the player, and continually determine as the music data proceeds whether the player can play correctly not only the pitch but also the intensity, duration, slur, staccato, tenuto, and the like, without interrupting the play. Thus automatic guidance of higher quality for playing an instrument may be realized.

In the present embodiment, notes and a score are displayed in the first area 41a in the uppermost section of the dot matrix display 41, a fingering mark in the second area 41b, and an image of fingers in the third area 41c as required, but this order may arbitrarily be changed, and notes and a score may be displayed in the lowermost third area. Alternatively, an image of fingers may be displayed in the first area 41a of the integral photography, and notes and a score in the third area 41c of the hologram display.

In the present embodiment, three-dimensional display technology is employed in the first area 41a to display a virtual stereo image. Instead, the first area 41a of the dot matrix display 41 may be made as an ordinary LCD dot matrix display and display a score thereon, a lens array having lenses corresponding to the respective keys of the keyboard 2 is arranged corresponding to and in front of this LCD dot matrix display, and a note on the score displayed on the LCD dot matrix display may be projected as an image of a note onto a corresponding key to be pressed. Since both the upper and lower staves of a grand staff are displayed on the LCD dot matrix, the lens array is correspondingly arranged in two rows or in partially separated two columns on right and left side of the middle C, so that both staves may be projected onto the keyboard 2. Even in this case, the guiding indication is not hidden by the hands of the player. Even if displayed at a position where it could be hidden by the hands of the player, the guiding indication is in practice projected onto the hands, so that the player may play, watching the guiding indication projected on his hands. The corresponding lens element itself of the lens array also sheds light, so that the guiding indication may be observed on the lens element. For the lens array, one-to-one erect imaging lens array or the like may be used. In any case, the guiding indication will not be hidden by the hands, and the player may play, watching the guiding indication, so that he can easily play even a piece which he has never played before.

In the discussions above, the fingering mark m displayed in the second area 41b is projected onto an appropriate key by the single lens array 42b. In this case, the position of the projected mark depends on the position of the first area 41b and the single lens array 42b, and the tilt and the focal length of each lens element of the single lens array 42b. Thus the single lens array 42 may be made independent from other parts, and mounted for back-and-forth tilting motion around the rotation axis provided on both sides in the center or lower part of the lens array, so that the position of projection may be adjusted. By adjusting the focal length and the tilt angle of the single lens array 42b, the fingering mark may be projected onto the overall surface of a relevant key. The fingering mark may, by default, point to the middle C key of the keyboard 2 upon power-on of the play assist device.

In the embodiments discussed above, a liquid crystal device is used as display means, but the dot matrix display 41 may be composed of light emitting diodes, organic EL, laser diodes, plasma, or the like. The projecting means may be a pinhole. The LCD may suitably be selected from transmissive LCD, reflective LCD, backlight LCD, or combinations thereof, depending on the state of use of each area.

What is claimed is:

1. A play assist device comprising:
display means for displaying upper and lower staves of a grand staff independently by a predetermined range,
projecting means for projecting images of said upper and lower staves of a grand staff above or onto a keyboard,
pressed key detection means for detecting a pressed key, and
control means for shifting said upper and lower staves so that a note to be played in the upper and lower staves is located at a position above or on the keyboard corresponding to said note.

2. The play assist device according to claim 1, wherein said display means displays an image of fingers at a position on the keyboard corresponding to a note to be played in the upper and lower staves.

3. The play assist device according to claim 1, wherein said control means determines whether or not to proceed with music data in accordance with a play mode wherein conditions for proceeding with music data have been set up.

4. The play assist device according to claim 1, further comprising position adjusting means for adjusting a position of an image of the upper and lower staves projected above or on the keyboard.

5. The play assist device according to claim 1, wherein at least a measure to be played now and a measure to be played next of said upper and lower staves of a grand staff are displayed, and every time the measure to be played now is finished, the measure to be played next is displayed as a new measure to be played now.

6. The play assist device according to claim 1, wherein information about a position on the keyboard corresponding to each note in the upper and lower staves of a grand staff and information about a distance between notes in the upper and lower staves are stored in advance, and said control means shifts the upper and lower staves in accordance with said stored information about a position on the keyboard and information about a distance.

7. The play assist device according to claim 3, wherein said control means measures time from causing display of the upper and lower staves until the pressed key detection means detects pressing of a key, and reflects measured time to said play mode.

8. The play assist device according to claim 1, wherein said control means synchronizes duration of notes in the upper and lower staves in the music data by the measure, and when a note in the upper staff is supposed to be played simultaneously with a note in the lower staff, said control means proceeds with a subsequent process only when it acquires both of the notes via the pressed key detection means detecting corresponding keys.

9. The play assist device according to claim 1, which is able to be set to automatically play the upper or lower staff of a grand staff.

10. The play assist device according to claim 1, wherein said control means synchronizes display of notes to be played simultaneously when the upper and lower staves contain notes of different values.

11. A keyboard instrument comprising:
display means for displaying upper and lower staves of a grand staff independently by a predetermined range,
projecting means for projecting images of the upper and lower staves of a grand staff above or onto a keyboard,
pressed key detection means for detecting a pressed key, and
control means for shifting said upper and lower staves so that a note to be played in the upper and lower staves is positioned above or on a key corresponding to said note.
